(19) United States
(12) Patent Application Publication
(10) Pub. No.: US 2008/0122779 A1
(43) Pub. Date: May 29, 2008

(54) Liquid crystal display with driving voltage temperature compensation

(75) Inventor: Wei-Chu Xu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: Innocom Technology (Shenzhen) Co., Ltd.; Innolux Display Corp.

(21) Appl. No.: 11/986,879

(22) Filed: Nov. 26, 2007

(30) Foreign Application Priority Data
Nov. 24, 2006 (CN) 200610157060.X

(51) Int. Cl. G02F 1/133; G09G 3/36

(52) U.S. Cl. 345/101; 349/72

(57) ABSTRACT

An exemplary liquid crystal display (200) includes a first substrate (210), a second substrate (220) parallel to the first substrate, a liquid crystal layer (230) between the first and second substrates, a resistivity sensor (280) adjacent to the liquid crystal layer, and a driver (260) configured to provide driving voltages to at least one of the first and second substrates. The resistivity sensor detects a resistivity of the liquid crystal layer, and the driver compensates the driving voltages according to the resistivity of the liquid crystal layer.

### FIELD OF THE INVENTION

The present invention relates to liquid crystal displays (LCDs), and more particularly to an LCD capable of automatically regulating driving voltages according to the ambient temperature.

### GENERAL BACKGROUND

LCDs are widely used in various modern information products, such as notebooks, personal digital assistants, video cameras and the like. Generally, when an LCD is in operation, driving voltages are applied to a liquid crystal layer of the LCD. The driving voltages cause liquid crystal molecules in the liquid crystal layer to tilt to corresponding angles, so as to control the amount of light beams transmitting through the liquid crystal layer.

The electro-optical characteristics of the liquid crystal molecules are apt to be influenced by ambient temperature, and this may reduce the display quality of the LCD. For example, when the ambient temperature decreases, the viscosity of the liquid crystal molecules is liable to increase. Due to the increase in viscosity, the tilting speed of the liquid crystal molecules may decrease, and so the response time of the LCD is liable to increase. Moreover, the tilting angles of the liquid crystal molecules may also be reduced. This is turn is liable to induce color shift in the LCD, and further reduce the contrast ratio of the LCD. To overcome the above-described problems, in general, a temperature compensation circuit is provided in the LCD.

Referring to FIG. 3, a conventional LCD having the function of temperature compensation is shown. The LCD 100 includes a first substrate 110, a second substrate 120, a temperature sensor 140, a micro controller unit (MCU) 150, a driver 160, and a sealant 170.

The second substrate 120 is parallel to the first substrate 110, and includes an exposed extending portion 122. The sealant 170 is disposed between the first substrate 110 and the second substrate 120. The first substrate 110, the second substrate 120, and the sealant 170 cooperatively define a closed accommodating space (not shown) therebetween. A liquid crystal layer (not shown) is sealed inside the accommodating space.

The temperature sensor 140, the MCU 150, and the driver 160 are all disposed on the extending portion 122 of the second substrate 120. The MCU 150 includes a first input bus 151, a second input bus 152, and an output bus 153. The first input bus 151 is electrically coupled to the temperature sensor 140, and is configured to receive digital codes generated by the temperature sensor 140. The second input bus 152 is configured to receive video data from an external video source. The output bus 153 is electrically coupled to the driver 160. Moreover, the MCU 150 further includes a look-up table (not shown) stored therein. The look-up table includes a plurality of compensation signals, each of which corresponds to a respective digital code transmitted from the temperature sensor 140.

In operation, firstly, the temperature sensor 140 detects the temperature of the second substrate 120, generates a corresponding digital code that functions as a temperature signal, and transmits the temperature signal to the MCU 150. Secondly, the MCU 150 receives the temperature signal from the temperature sensor 140, and looks up a corresponding compensation signal in the look-up table. Thirdly, the MCU 150 receives video data via the second input bus 152, generates compensated data signals by compensating the video data according to the compensation signal, and transmits the compensated data signals to the driver 160. Finally, the driver 160 receives the compensated data signals, converts the compensated data signals to driving voltages, and drives the LCD 100 to display images by applying the driving voltages to the liquid crystal layer 130.

Thus the LCD 100 compensates the driving voltages according to the temperature of the second substrate 120, and the display quality of the LCD 100 is improved. However, the LCD 100 does not carry out the function of temperature compensation based on direct monitoring of the liquid crystal material itself. As a result, the temperature compensation may still be inaccurate, and the display quality of the LCD 100 may still be unsatisfactory.

It is, therefore, desired to provide an LCD which overcomes the above-described deficiencies.

### SUMMARY

In one aspect, a liquid crystal display includes a first substrate, a second substrate parallel to the first substrate, a liquid crystal layer between the first and second substrates, a resistivity sensor adjacent to the liquid crystal layer, and a driver configured to provide driving voltages to at least one of the first and second substrates. The resistivity sensor detects a resistivity of the liquid crystal layer, and the driver compensates the driving voltages according to the resistivity of the liquid crystal layer.

In another aspect, a liquid crystal display includes a first substrate, a second substrate parallel to the first substrate, a liquid crystal layer between the first and second substrates, a sensor adjacent to the liquid crystal layer, and a driver configured to provide driving voltages to at least one of the first and second substrates. The sensor includes a first electrode provided at the first substrate and a second electrode provided at the second substrate. The driver outputs a voltage signal to the first electrode, receives a current signal from the second electrode, and compensates the driving voltages according to the current signal.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an isometric view of part of an LCD according to an exemplary embodiment of the present invention.

FIG. 2 is a cross-sectional view taken along line II-II of FIG. 1.

FIG. 3 is an isometric view of part of a conventional LCD.

### DETAILED DESCRIPTION OF PREFERRED EMBODIMENTS

Reference will now be made to the drawings to describe preferred and exemplary embodiments of the present invention in detail.

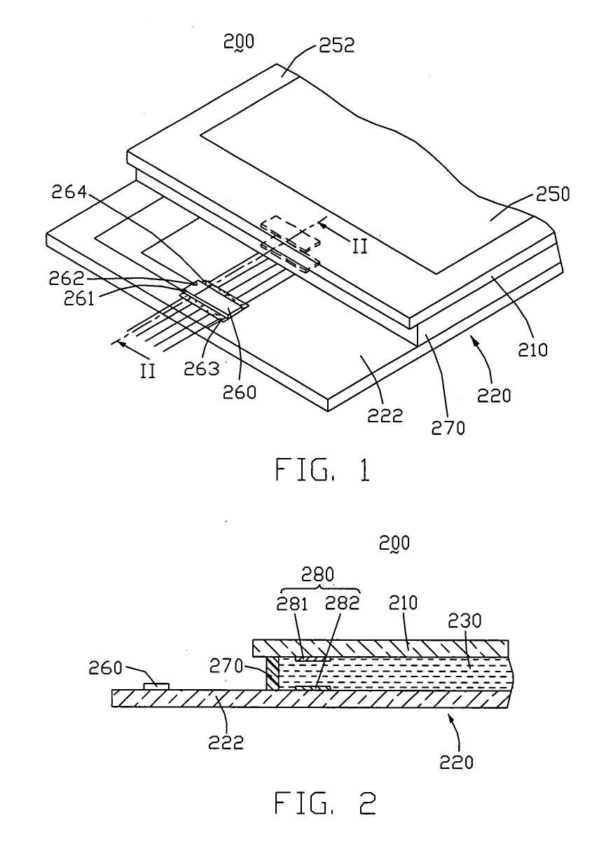

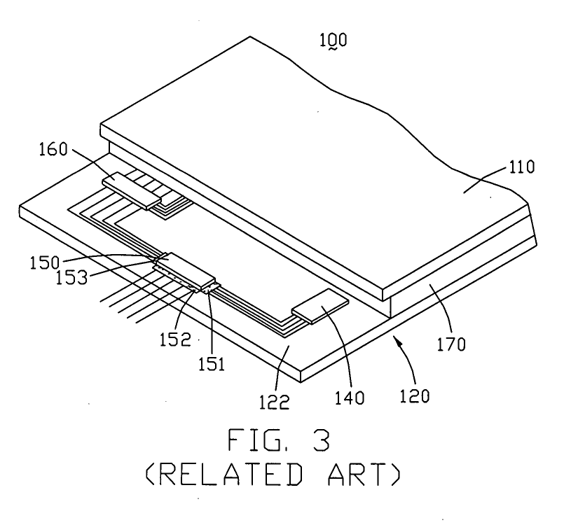

Referring to FIGS. 1-2, aspects of an LCD according to an exemplary embodiment of the present invention are shown. The LCD 200 includes a first substrate 210, a second substrate 220, a liquid crystal layer 230, a driver 260, a sealant 270, and a resistivity sensor 280.

The first substrate 210 and the second substrate 220 are flat plate substrates arranged parallel to each other. Each of the first and second substrates 210, 220 includes wires (not labeled) disposed thereon. The first substrate 210 is a color filter substrate. The second substrate 220 is a thin film transistor substrate, which includes an exposed extending portion 222.

The sealant 270 is disposed between the first substrate 210 and the second substrate 220, at peripheries of the first and second substrates 210, 220. The sealant 270 includes electrically conductive particles dispensed in a base material thereof. Material of the particles can be silver. The sealant 270, the first substrate 210 and the second substrate 220 cooperatively define a closed accommodating space. The liquid crystal layer 230 is sealed in the accommodating space, and is surrounded by the sealant 270. The first and second substrates 210, 220, together with the liquid crystal layer 230 and sealant 270 therebetween, define a main central active area 250 of the LCD 200 and a peripheral non-active area 252 of the LCD 200 surrounding the active area 250. The active area 250 is configured to be a display area, at which images displayed by the LCD 200 can be seen.

The resistivity sensor 280 is configured to detect the resistivity of the liquid crystal layer 230, and includes a first electrode 281 and a second electrode 282. The first electrode 281 and the second electrode 282 are both thin film electrodes disposed at the non-active area 252. The first electrode 281 is disposed on a surface of the first substrate 210 that is adjacent to the liquid crystal layer 230, and the second electrode 282 is disposed on a surface of the second substrate 220 that is adjacent to the liquid crystal layer 230. The first electrode 281 has a shape and a size the same as that of the second electrode 282, and the first electrode 281 is aligned directly above the second electrode 282. Both of the first and second electrodes 281, 282 are made of metal with high electrical conductivity, such as chromium, aluminum, copper, and the like.

The driver 260 is disposed at the extending portion 222 of the second substrate 220. The driver 260 includes a voltage output terminal 261, a current input terminal 262, an input bus 263, and an output bus 264. The voltage output terminal 261 is electrically coupled to the first electrode 281 via a respective wire disposed at each of the first and second substrates 210 and 220, as well as the conductive particles in the sealant which interconnects the two wires. The current input terminal 262 is electrically coupled to the second electrode 282 via another wire disposed at the second substrate 220. The input bus 263 is configured to receive video data from an external video source, such as a video card in a computer. The output bus 264 is configured to output driving voltages to the active area 250 for driving the LCD 200 to display images. The driver 260 further includes an analog to digital (A/D) converter (not shown) embedded therein, and a look-up table (not shown) stored integrally. The A/D converter is configured to convert an input current received by the current input terminal 262 to a digital signal, and encode the digital signal to a binary code. The look-up table includes a plurality of compensation signals, each of which corresponds to a respective binary code.

In operation, the driver 260 outputs a fixed direct voltage V₀ to the first electrode 281 and the second electrode 282. Due to the voltage V₀, a current I₀ is generated. The current I₀ passes through the part of liquid crystal layer 230 between the first electrode 281 and the second electrode 282, and then is received by the driver 260 via the current input terminal 262.

Based on the current I₀, a resistance R of the liquid crystal layer 230 can be calculated according to the formula: R=V₀/I₀. Moreover, the resistance R can also be calculated by the following formula: R=ρL/S, where the symbol ρ represents a resistivity of the liquid crystal layer 230, L represents the thickness of the liquid crystal layer 230, and S represents the area of the surface of each of the first and second electrodes 281, 282 that faces the other second or first electrode 282, 281. Therefore, the resistivity ρ of the liquid crystal layer 230 can be obtained by the following formula: ρ=V₀S/I₀L. Because each of the voltage V₀, the area S, and the thickness L has a fixed value, the resistivity ρ of the liquid crystal layer 230 is inversely proportional to the current I₀. The fraction V₀S/L can be expressed as a constant K; i.e., K=V₀S/L. Thus ρ is directly proportional to K/I₀; i.e. ραK/I₀.

When the LCD 200 is in a normal working state, the physical characteristics of the liquid crystal layer 230 are stable. The driver 260 receives video data via the input bus 263, converts the video data to corresponding driving voltages, and then outputs the driving voltages to the active area 250. The liquid crystal molecules tilt to corresponding angles according to the driving voltages, so as to control the amount of light beams transmitted through the liquid crystal layer 230. Thereby, the LCD 200 displays images.

When the ambient temperature changes, the temperature of the liquid crystal layer 230 varies accordingly. In this situation, physical characteristics of the liquid crystal layer 230, such as the viscosity and the resistivity ρ, also tend to vary. As described above, the varying of the viscosity is liable to influence the tilting speed and the tilting angle of the liquid crystal molecules in the liquid crystal layer 230, and the varying of the resistivity ρ influences a value of the current I₀. Because both the viscosity and the resistivity ρ vary according to the temperature, the varying of the viscosity can be measured via the varying of the resistivity ρ of the liquid crystal layer 230. As detailed above, the resistivity ρ can be calculated by the formula: ρ=V₀S/I₀L. Therefore the varying of the viscosity can be monitored based on the varying of the resistivity ρ (or the value of the current I₀).

In detail, when the ambient temperature decreases, the viscosity of the liquid crystal layer 230 increases accordingly. If the driver 260 were to output the same driving voltage as before the temperature decrease, the increase in the viscosity would be liable to reduce the tilting speed and the tilting angle of the liquid crystal molecules. However, at the same time the ambient temperature decreases, the resistivity ρ of the liquid crystal layer 230 increases, which causes the current I₀ to be reduced. The driver 260 receives the current I₀, converts the current I₀ to a digital signal, and encodes the digital signal via the A/D converter so as to provide a binary code. The driver 260 then looks up a corresponding compensation signal in the look-up table according to the binary code, and then adds the compensation signal to the original driving voltage so as to provide a compensated driving voltage. The compensated driving voltage is finally outputted to the active area 250 via the output bus 264, and drives the LCD 200 to display images. Because the compensated driving voltage is greater than the original driving voltage, it causes the liquid crystal molecules to tilt at the desired tilting speed to the desired angle, just as before decrease in the ambient temperature.

Conversely, when the ambient temperature increases, the viscosity and the resistivity ρ of the liquid crystal layer 230 decrease. These conditions respectively induce an increase in the tilting angle and an increase in the current I₀. The driver 260 provides a binary code corresponding to the current I₀, looks up a corresponding compensation signal according to the binary code, and then subtracts the compensation signal from the original driving voltage so as to provide a compensated driving voltage. The compensated driving voltage is smaller than the original driving voltage, and is able to prevent the liquid crystal molecules from tilting too much. That is, the liquid crystal molecules tilt to the desired angle, just as before increase in the ambient temperature.

As described above, the LCD 200 detects the resistivity ρ of the liquid crystal layer 230 via the resistivity sensor 280, and compensates the driving voltages according to the resistivity ρ under different temperature conditions. Because the LCD 200 compensates the driving voltages according to the physical characteristics of the liquid crystal layer 230, the accuracy of the temperature compensation is improved. Therefore, the display quality of the LCD 200 is also improved.

In various alternative embodiments, the current I₀ can be first amplified by the driver 260 before being converted to a digital signal. The driver 260 can be disposed at the first substrate 210, or disposed at one of a printed circuit board (PCB) and a flexible printed circuit board (FPCB). The material of the first and second electrodes 281 and 282 can be indium tin oxide (ITO) or an alloy having low resistivity.

It is to be further understood that even though numerous characteristics and advantages of preferred and exemplary embodiments have been set out in the foregoing description, together with details of the structures and functions of the embodiments, the disclosure is illustrative only; and that changes may be made in detail within the principles of the present invention to the full extent indicated by the broad general meaning of the terms in which the appended claims are expressed.

What is claimed is:

1. A liquid crystal display, comprising:
a first substrate;
a second substrate parallel to the first substrate;
a liquid crystal layer between the first and second substrates;
a resistivity sensor adjacent to the liquid crystal layer; and
a driver configured to provide driving voltages to at least one of the first and second substrates;
wherein the resistivity sensor detects a resistivity of the liquid crystal layer, and the driver compensates the driving voltages according to the resistivity of the liquid crystal layer.

2. The liquid crystal display as claimed in claim 1, wherein the resistivity sensor comprises a first electrode and a second electrode, the first electrode is disposed on the first substrate, the second electrode is disposed on the second substrate.

3. The liquid crystal display as claimed in claim 2, wherein the first and second electrodes are both thin film electrodes.

4. The liquid crystal display as claimed in claim 3, wherein the first electrode has a shape and a size the same as that of the second electrode.

5. The liquid crystal display as claimed in claim 3, wherein the first electrode is aligned directly above the second electrode.

6. The liquid crystal display as claimed in claim 3, wherein the first and second electrodes are both made of a selected one of metal, alloy, and indium tin oxide.

7. The liquid crystal display as claimed in claim 3, wherein the first and second electrodes are both made of a selected one of chromium, aluminum, and copper.

8. The liquid crystal display as claimed in claim 1, further comprising a sealant between the first and second substrates, wherein the sealant, the first substrate, and the second substrate cooperatively define an accommodating space for receiving the liquid crystal layer, and the resistivity sensor is disposed in the accommodating space and adjacent to the sealant.

9. The liquid crystal display as claimed in claim 8, wherein the sealant comprises electrically conductive particles dispensed inside.

10. The liquid crystal display as claimed in claim 1, wherein material of the conductive particles is silver.

11. The liquid crystal display as claimed in claim 1, wherein the driver comprises a look-up table stored integrally, the look-up table comprises a plurality of compensation signals corresponding to different temperature.

12. A liquid crystal display, comprising:
a first substrate;
a second substrate parallel to the first substrate;
a liquid crystal layer between the first and second substrates;
a resistivity sensor adjacent to the liquid crystal layer, the resistivity sensor comprising a first electrode provided at the first substrate and a second electrode provided at the second substrate; and
a driver configured to provide driving voltages to at least one of the first and second substrates;
wherein the driver outputs a voltage signal to the first electrode, receives a current signal from the second electrode, and compensates the driving voltages according to the current signal.

13. The liquid crystal display as claimed in claim 12, wherein the driver comprises an analog to digital converter configured to convert the current signal to a digital signal.

14. The liquid crystal display as claimed in claim 13, wherein the driver further comprises a look-up table, the look-up table comprises a plurality of compensation signals, each of which corresponds to a digital signal.

15. The liquid crystal display as claimed in claim 14, wherein the driver compensates the driving voltages via adding the driving voltages to the corresponding compensation signals or subtracting the corresponding compensation signals from the driving voltages.

16. The liquid crystal display as claimed in claim 15, wherein driver adds the driving voltages to the corresponding compensation signals when the temperature decrease, and subtract the corresponding compensation signals from the driving voltages when the temperature increase.

17. The liquid crystal display as claimed in claim 12, wherein the first electrode is aligned directly above the second electrode.

18. The liquid crystal display as claimed in claim 17, wherein the first electrode has a shape and a size the same as that of the second electrode.

19. The liquid crystal display as claimed in claim 17, wherein the first and second electrodes are both made of one of chromium, aluminum, and copper.

20. A liquid crystal display, comprising:
a first substrate;
a second substrate parallel to the first substrate;
a liquid crystal layer between the first and second substrates;
a first electrode provided at the first substrate and a second electrode provided at the second substrate and both embedded in said liquid crystal layer; and
a driver configured to provide driving voltages to at least one of the first and second substrates;
wherein the driver outputs a voltage signal to the first electrode, receives a current signal from the second electrode, and compensates the driving voltages according to the current signal.
